(19) United States
(12) Patent Application Publication
(10) Pub. No.: US 2024/0421354 A1
(43) Pub. Date: Dec. 19, 2024

(54) ELECTROLYTE FOR LITHIUM SECONDARY BATTERY AND LITHIUM SECONDARY BATTERY

(71) Applicant: TeraWatt Technology K.K., Yokohama-shi (JP)

(72) Inventors: Gosuke Oyama, Yokohama-shi (JP); Ken Ogata, Yokohama-shi (JP); Kazuki Takimoto, Yokohama-shi (JP)

(73) Assignee: TeraWatt Technology K.K., Yokohama-shi (JP)

(21) Appl. No.: 18/816,609

(22) Filed: Aug. 27, 2024

Related U.S. Application Data
(63) Continuation of application No. PCT/JP2022/009140, filed on Mar. 3, 2022.

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0034

(57) ABSTRACT

The present invention provides an electrolyte solution for a lithium secondary battery, which can achieve both a high energy density and excellent cycle characteristics. The present invention relates to an electrolyte solution for a lithium secondary battery, the electrolyte solution including a cyclic compound represented by Formula (1) or Formula (2), a hydrofluoroether, an ether not having a fluorine atom, and a lithium salt.

### CROSS-REFERENCE TO RELATED APPLICATION

This application is a continuation of international patent application no. PCT/JP2022/009140, entitled “Electrolyte Solution for Lithium Secondary Battery and Lithium Secondary Battery”, filed Mar. 3, 2022, the entire contents of which are hereby incorporated by reference.

### BACKGROUND

### Field

The present invention relates to an electrolyte solution for a lithium secondary battery and a lithium secondary battery.

### Description of Related Art

The technology for converting natural energy such as solar light and wind power into electric energy has recently attracted attentions. Under such a situation, various secondary batteries have been developed as a power storage device which is highly safe and can store a lot of electric energy.

Among those, lithium secondary batteries in which charge/discharge are performed by transferring lithium ions between a positive electrode and a negative electrode are known to exhibit a high voltage and a high energy density. As typical lithium secondary batteries, a lithium-ion secondary battery (LIB) which has a positive electrode and a negative electrode having an active material capable of retaining a lithium element, and is subjected to charge/discharge by transferring or receiving lithium ions between a positive-electrode active material and a negative-electrode active material is known.

In addition, for the purpose of realizing a high energy density and improving productivity, a lithium-metal secondary battery (LMB) using lithium metal as a negative-electrode active material or an anode-free battery (AFB) that uses a negative electrode consisting of a negative electrode current collector not having a negative-electrode active material such as a carbon material or lithium metal, instead of a material into which lithium ions can be inserted, such as a carbon material, as a negative-electrode active material, has been developed.

On the other hand, a lithium secondary battery capable of achieving a high voltage has a problem in that the cycle characteristics of the lithium secondary battery are deteriorated due to a high reactivity between the members of the battery and an electrolyte solution. Therefore, there is a demand for measures to prevent the consumption of the electrolyte solution in the case where repeated charge/discharge are performed, as well as to prevent a decrease in battery capacity due to such a reaction. For example, Japanese Patent Application Laid-Open No. 2002-056892 discloses that an organic electrolyte solution secondary battery containing, in an electrolyte solution, a nonionic aromatic compound selected from the group consisting of a trimellitic acid ester or a derivative thereof, a tertiary butyl ester or a derivative thereof, tertiary butylbenzene, isobutylbenzene, and cyclohexylbenzene has a significantly reduced reactivity with the electrolyte solution at a high temperature, and thus, the safety of the battery is improved.

### SUMMARY

However, in lithium secondary batteries in the related art, including the lithium secondary battery described in the patent literature, a decomposition reaction of an electrolyte solution occurs before a reduction reaction of lithium occurs. Therefore, there was a problem in that an irreversible decomposition reaction of the electrolyte solution occurs in each cycle as charge/discharge of the battery are performed. It was found that such a lithium secondary battery having the electrolyte solution, continues to expand due to repeated charge/discharge of the battery, and as a result, the electrolyte solution does not fill an electrode (that is, the electrolyte solution shortage occurs), causing a cell capacity to decrease.

The present invention has been made in consideration of the problems, and has an object to provide an electrolyte solution which achieves both a high energy density and excellent cycle characteristics in a lithium secondary battery.

An electrolyte solution for a lithium secondary battery according to one embodiment of the present invention includes a cyclic compound represented by Formula (1) or Formula (2), a hydrofluoroether, an ether not having a fluorine atom, and a lithium salt. In addition, in Formula (1), n is an integer of 0 or more and 3 or less, and R^{a} is a monovalent saturated hydrocarbon group having 1 or more and 10 or less carbon atoms, and in Formula (2), m is an integer of 0 or more and 3 or less, and R^{h} is a monovalent saturated hydrocarbon group having 1 or more and 10 or less carbon atoms.

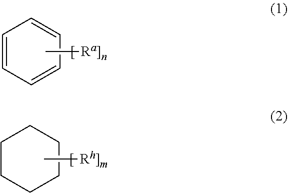

The present inventors have found that by configuring the electrolyte solution in the lithium secondary battery to include the compound represented by Formula (1) or Formula (2), it is possible to achieve both high charge/discharge efficiency in a case of repeated charge/discharge and an increase in the volume of the electrolyte solution per unit weight. In addition, by configuring the electrolyte solution to include the hydrofluoroether as a solvent, the reversibility of an oxidation-reduction reaction of lithium on a surface of the negative electrode in a case where repeated charge/discharge of the battery are performed is improved, and the compatibility between the solvents and the discharge characteristics at low temperatures are also improved. Furthermore, by configuring the electrolyte solution to include the ether not having a fluorine atom as the solvent therein, the solubility of electrolytes such as a lithium salt is improved. Therefore, it is presumed that each component of the above-described solvent synergistically improves the energy density and the cycle characteristics of the lithium secondary battery. The factor is, however, not limited to the aforesaid one.

In the electrolyte solution according to one embodiment of the present invention, it is preferable that the amount of the cyclic compound is 5% by volume or more and 60% by volume or less with respect to a total amount of the solvent components of the electrolyte solution. According to such an aspect, the lithium secondary battery tends to have more excellent energy density and/or cycle characteristics.

In the electrolyte solution according to one embodiment of the present invention, it is preferable that the cyclic compound is included in an amount of 10% by volume or more and 55% by volume or less with respect to the total amount of the solvent components of the electrolyte solution. According to such an aspect, the lithium secondary battery tends to have more excellent energy density and/or cycle characteristics.

In the electrolyte solution according to one embodiment of the present invention, it is preferable that in Formula (1), n is 1. According to such an aspect, the lithium secondary battery tends to have more excellent cycle characteristics.

In the electrolyte solution according to one embodiment of the present invention, it is preferable that in Formula (2), m is 0 or 1. According to such an aspect, the lithium secondary battery tends to have more excellent cycle characteristics.

It is preferable that the electrolyte solution according to one embodiment of the present invention includes the cyclic compound represented by Formula (1). According to such an aspect, the lithium secondary battery tends to have more excellent cycle characteristics.

In the electrolyte solution according to one embodiment of the present invention, it is preferable that a specific gravity of the electrolyte solution is 1.0 g/cc or more and 1.3 g/cc or less. According to such an aspect, the lithium secondary battery tends to have a more excellent energy density.

In the electrolyte solution according to one embodiment of the present invention, it is preferable that the cyclic compound is at least one selected from the group consisting of n-butylbenzene, tert-butylbenzene, isobutylbenzene, sec-butylbenzene, propylbenzene, ethyltoluene, 1,3,5-trimethylbenzene, cyclohexane, methylcyclohexane, and ethylcyclohexane. According to such an aspect, the lithium secondary battery tends to have more excellent energy density and/or cycle characteristics.

In the electrolyte solution according to one embodiment of the present invention, it is preferable that the ether not having a fluorine atom is 1,2-dimethoxyethane, 1,2-dimethoxypropane, or a mixture thereof. According to such an aspect, the lithium secondary battery tends to have more excellent cycle characteristics.

In the electrolyte solution according to one embodiment of the present invention, it is preferable that the lithium salt includes LiN(SO₂F)₂. According to such an aspect, the lithium secondary battery tends to have more excellent cycle characteristics.

In the electrolyte solution according to one embodiment of the present invention, it is preferable that the hydrofluoroether is a chain-like fluorine compound having at least one of a monovalent group represented by Formula (A) or a monovalent group represented by Formula (B). According to such an aspect, the lithium secondary battery tends to have more excellent cycle characteristics. In addition, in Formulae (A) and (B), a wavy line represents a bonding site in the monovalent group.

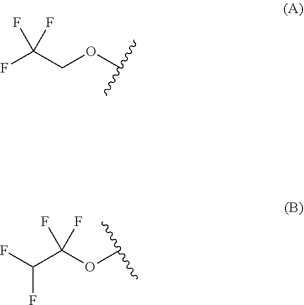 [SMILES: *OCC(F)(F)F ; *OC(F)(F)C(F)F]

The lithium secondary battery according to one embodiment of the present invention includes the electrolyte solution described in any one of the aspects. According to such an aspect, the lithium secondary battery is excellent in both the energy density and the cycle characteristics.

In the lithium secondary battery according to one embodiment of the present invention, it is preferable that lithium metal is deposited on a surface of the negative electrode and the deposited lithium metal is dissolved to perform charge/discharge. According to such an aspect, the lithium secondary battery tends to further improve the effect of the electrolyte solution.

It is preferable that the lithium secondary battery according to one embodiment of the present invention includes a negative electrode consisting of a negative electrode current collector not having a negative-electrode active material. According to such an aspect, the lithium secondary battery tends to further improve the effect of the electrolyte solution.

According to the present invention, it is possible to provide an electrolyte solution which achieves both a high energy density and excellent cycle characteristics in a lithium secondary battery.

### BRIEF DESCRIPTION OF DRAWINGS

FIG. 1 is a schematic cross-sectional view of a lithium secondary battery according to one embodiment of the present invention.

### DETAILED DESCRIPTION

The embodiment of the present invention (which will hereinafter be referred to as “the present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship illustrated in the drawings. The dimensional ratios shown in the drawings are not limited to the depicted ratios.

### [Electrolyte Solution]

The electrolyte solution is a solution containing an electrolyte and a solvent, and having ion conductivity, and acts as a conductive path for lithium ions in a lithium secondary battery. The electrolyte solution may be used in a form of being impregnated into a separator, in a form of being encapsulated into a hermetically sealing container together with a laminate of a positive electrode, a separator, and a negative electrode, or may be as a material of a member configured to fill the separator.

The electrolyte solution according to the present embodiment includes a cyclic compound represented by Formula (1) or Formula (2) (hereinafter also referred to as a cyclic compound of Formula (1) or a cyclic compound of Formula (2)), a hydrofluoroether, and an ether not having a fluorine atom as a solvent. In addition, in Formula (1), n is an integer of 0 or more and 3 or less, and R^{a} is a monovalent saturated hydrocarbon group having 1 or more and 10 or less carbon atoms, and in Formula (2), m is an integer of 0 or more and 3 or less, and R^{h} is a monovalent saturated hydrocarbon group having 1 or more and 10 or less carbon atoms.

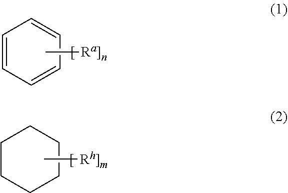

In the lithium secondary battery, in a case where discharge or charge is performed, an oxidation or reduction reaction of lithium proceeds, making it possible to extract or store energy. In this case, a decomposition reaction of the electrolyte solution generally occurs more easily than an oxidation-reduction reaction of lithium, and thus, the irreversible decomposition of the electrolyte solution causes the volume of the battery to expand each time a charge/discharge cycle is performed. As a result, it has been found that the shortage of the electrolyte solution (dry-up state), in which the electrolyte solution does not fill an electrode, occurs, and the capacity of the battery is also reduced.

As a result of intensive studies, the present inventors have found that by using at least one of the cyclic compound of Formula (1) and the cyclic compound of Formula (2) as a solvent in a lithium secondary battery, the volume of the electrolyte solution per unit weight can be increased and the irreversible decomposition reaction of the electrolyte solution can be suppressed in a case where a charge/discharge cycle is performed. The factor is presumed as follows, but is not limited thereto.

The cyclic compounds of Formula (1) and Formula (2) each have a benzene ring or a cyclohexane skeleton, and do not have a substituent other than a saturated hydrocarbon group. Such compounds are bulky due to the restricted molecular motion, and furthermore, the polarity of the molecule is low, resulting in the restricted interaction between the molecules. Therefore, the number of molecules per unit volume is small and the density of the compounds is low. As a result, in the lithium secondary battery using such an electrolyte solution, the energy per unit weight increases and the mass-based energy density of the lithium secondary battery is improved. Furthermore, since the cyclic compounds of Formula (1) and Formula (2) do not have reactive groups, they have high oxidation stability. Therefore, it is presumed that since an irreversible decomposition reaction is suppressed in an electrolyte solution including such compounds, the cycle characteristics of the battery are improved.

On the other hand, the hydrofluoroether is a compound including fluorine and hydrogen, and is likely to cause a reaction on a surface of the negative electrode during the charge/discharge of the lithium secondary battery. In a case where the charge/discharge of a lithium secondary battery having an electrolyte solution including such a compound are performed, a solid electrolyte interfacial layer (SEI layer) is formed on a surface of the negative electrode or the like by decomposing the hydrofluoroether and the like in the electrolyte solution. In particular, in a case where the electrolyte solution includes the hydrofluoroether, it is presumed that an SEI layer having a high fluorine content is suitably formed at the time of charging the lithium secondary battery. It is presumed that such an SEI layer suppresses further decomposition of components in the electrolyte solution, and suppresses irreversible reduction and the like of lithium ions in the lithium secondary battery.

In addition, it is presumed that by configuring the electrolyte solution according to the present embodiment to include an ether not having a fluorine atom, the solubility of the lithium salts in the electrolyte solution is further improved, the internal resistance of the lithium secondary battery including the electrolyte solution is reduced, and the properties of the SEI layer to be formed are made suitable.

Therefore, it is considered that the lithium secondary battery including the electrolyte solution of the present embodiment can achieve both a high energy density and excellent cycle characteristics as the synergistic effect due to the characteristics of each of the above-described components. The factor is, however, not limited to the aforesaid one.

Hereinafter, each component included in the electrolyte solution will be described in detail.

### (Cyclic Compound of Formula (1) and Cyclic Compound of Formula (2))

The electrolyte solution according to the present embodiment includes the cyclic compound of Formula (1) or Formula (2).

The electrolyte solution may include at least one of the cyclic compound of Formula (1) and the cyclic compound of Formula (2), may include only the cyclic compound of Formula (1) or only the cyclic compound of Formula (2), or may include both the cyclic compound of Formula (1) and the cyclic compound of Formula (2).

In addition, in a case where a plurality of saturated hydrocarbon groups are present in the cyclic compounds represented by Formulae (1) and (2), R^{a}'s or R^{h}'s in the plurality of saturated hydrocarbon groups are each independently selected. That is, in the present specification, the structures of the plurality of R^{a}'s or the plurality of R^{h}'s may be the same as or different from each other.

It is preferable that the electrolyte solution according to the present embodiment includes the cyclic compound represented by Formula (1). In a case where the electrolyte solution includes the cyclic compound of Formula (1), the cycle characteristics of the lithium secondary battery tend to be further improved. In Formula (1), n is an integer of 0 or more and 3 or less. From the viewpoints of improving the oxidation stability of the electrolyte solution and further improving the cycle characteristics of a lithium secondary battery having the electrolyte solution, n is preferably 1 or 2, and more preferably 1.

In Formula (1), R^{a} may be a chain-like saturated hydrocarbon group and may be a cyclic saturated hydrocarbon group. From the viewpoint of further improving the effect of the electrolyte solution of the present embodiment, it is preferable that R^{a} represents a chain-like saturated hydrocarbon group. The chain-like saturated hydrocarbon group may be linear or may have a branched chain. Furthermore, in the present specification, the cyclic saturated hydrocarbon group refers to a saturated hydrocarbon group having at least one cyclic structure.

In Formula (1), in a case where n is 1, the number of carbon atoms in R^{a} is preferably 2 or more and 10 or less. In a case where the number of carbon atoms in R^{a} is within the ranges, the effect of the electrolyte solution of the present embodiment tends to be further improved. From the same viewpoint, in a case where n is 1, the number of carbon atoms in R^{a} is preferably 2 or more and 8 or less, more preferably 3 or more and 6 or less, and still more preferably 4 or 5.

In addition, from the same viewpoint as above, in a case where n is 2 or 3, the numbers of carbon atoms of R^{a}'s are each independently preferably 1 or more and 8 or less, more preferably 1 or more and 5 or less, still more preferably 1 or more and 3 or less, and even still more preferably 1 or 2.

In Formula (1), the total number of carbon atoms in R^{a} in a case where a plurality of R^{a}'s are present is not particularly limited, and is, for example, 2 or more and 30 or less. From the viewpoint of further improving the effect of the electrolyte solution of the present embodiment, the total number of carbon atoms in R^{a}'s is preferably 2 or more and 10 or less, and more preferably 3 or more and 6 or less.

In Formula (1), R^{a} may have a branched chain. In a case where R^{a} has a branched chain, the cycle characteristics of a lithium secondary battery having the electrolyte solution tend to be further improved. From the same viewpoint, the cyclic compound of Formula (1) preferably has at least one secondary or tertiary carbon atom, and more preferably has at least one tertiary carbon atom, in the compound.

A molecular weight of the cyclic compound of Formula (1) of the present embodiment is not particularly limited, and is, for example, 106 or more and 500 or less. From the viewpoint of further improving the cycle characteristics of a lithium secondary battery having the electrolyte solution, the molecular weight of the cyclic compound of Formula (1) is preferably 106 or more and 220 or less, more preferably 106 or more and 180 or less, still more preferably 106 or more and 150 or less, and even still more preferably 115 or more and 140 or less.

A specific gravity of the cyclic compound of Formula (1) in the electrolyte solution at 25° C. is not particularly limited, and is, for example, 0.7 g/cc or more and 1.2 g/cc or less. From the viewpoint of further improving the energy density of a lithium secondary battery including the electrolyte solution, the specific gravity of the cyclic compound of Formula (1) at 25° C. is more preferably 1.1 g/cc or less, still more preferably 1.0 g/cc or less, and even still more preferably 0.9 g/cc or less.

The cyclic compound of Formula (1) in the present embodiment is not particularly limited as long as it is a compound represented by Formula (1), and examples thereof include butylbenzene, isobutylbenzene, tert-butylbenzene, propylbenzene, 2-ethyltoluene, 1,3,5-trimethylbenzene (mesitylene), ethylbenzene, xylene, 1,2,3-trimethylbenzene, 1,2,4-trimethylbenzene, 3-ethyltoluene, 4-ethyltoluene, cumene, 1,3-diethylbenzene, 1,4-diethylbenzene, sec-butylbenzene, o-cymene, p-cymene, 1,2-diethylbenzene, pentylbenzene, neopentylbenzene, tert-amylbenzene, and isopentylbenzene. From the viewpoint of further improving the effect of the electrolyte solution of the present embodiment, it is preferable to use butylbenzene, isobutylbenzene, tert-butylbenzene, propylbenzene, ethyltoluene, or 1,3,5-trimethylbenzene as the cyclic compound of Formula (1).

In addition, the cyclic compound of Formula (1) may be used alone or in combination with two or more kinds thereof.

In Formula (2), m is an integer of 0 or more and 3 or less. From the viewpoints of improving the oxidation stability of the electrolyte solution and further improving the cycle characteristics of a lithium secondary battery having the electrolyte solution, m is preferably 0 or more and 2 or less, more preferably 0 or 1, and still more preferably 1.

In Formula (2), R^{h} may be a chain-like saturated hydrocarbon group or a cyclic saturated hydrocarbon group. From the viewpoint of further improving the effect of the electrolyte solution of the present embodiment, it is preferable that R^{h} represents a chain-like saturated hydrocarbon group. The chain-like saturated hydrocarbon group may be linear or may have a branched chain. Furthermore, in the present specification, the cyclic saturated hydrocarbon group refers to a saturated hydrocarbon group having at least one cyclic structure.

In Formula (2), the number of carbon atoms in R^{h} is 1 or more and 10 or less. From the viewpoint of further improving the effect of the electrolyte solution of the present embodiment, the number of carbon atoms in R^{h} is preferably 1 or more and 8 or less, more preferably 1 or more and 5 or less, and still more preferably 1 or 2.

In Formula (2), R^{h} may be linear. According to such an aspect, the cycle characteristics of a lithium secondary battery having the electrolyte solution tend to be further improved.

A molecular weight of the cyclic compound of Formula (2) of the present embodiment is not particularly limited, and is, for example, 84 or more and 500 or less. From the viewpoint of further improving the cycle characteristics of a lithium secondary battery having the electrolyte solution, the molecular weight of the cyclic compound of Formula (2) is preferably 84 or more and 220 or less, more preferably 84 or more and 180 or less, and still more preferably 84 or more and 150 or less.

A specific gravity of the cyclic compound of Formula (2) included in the electrolyte solution at 25° C. is not particularly limited, and is, for example, 0.7 g/cc or more and 1.2 g/cc or less. From the viewpoint of further improving the energy density of a lithium secondary battery including the electrolyte solution, the specific gravity of the cyclic compound of Formula (2) at 25° C. is more preferably 1.1 g/cc or less, more preferably 1.0 g/cc or less, and still more preferably 0.9 g/cc or less.

The cyclic compound of Formula (2) in the present embodiment is not particularly limited as long as it is a compound represented by Formula (2), and examples thereof include cyclohexane, methylcyclohexane, ethylcyclohexane, propylcyclohexane, butylcyclohexane, tert-butylcyclohexane, isobutylcyclohexane, 1,4-dimethylcyclohexane, and 1,3,5-trimethylcyclohexane. From the viewpoint of further improving the effect of the electrolyte solution of the present embodiment, it is preferable to use one selected from the group consisting of cyclohexane, methylcyclohexane, and ethylcyclohexane as the cyclic compound of Formula (2). In addition, the cyclic compounds of Formula (1) and Formula (2) in the present embodiment are not particularly limited as long as they are compounds represented by Formula (1) and Formula (2), but from the same viewpoint as above, the cyclic compounds are each preferably at least one selected from the group consisting of n-butylbenzene, tert-butylbenzene, isobutylbenzene, sec-butylbenzene, propylbenzene, ethyltoluene, 1,3,5-trimethylbenzene, cyclohexane, methylcyclohexane, and ethylcyclohexane.

In the electrolyte solution, a total content of the cyclic compound of Formula (1) and the cyclic compound of Formula (2) is preferably 5% by volume or more and 60% by volume or less, more preferably 10% by volume or more and 55% by volume or less, still more preferably 15% by volume or more and 50% by volume or less, and even still more preferably 20% by volume or more and 45% by volume or less. In a case where the total content of the cyclic compound of Formula (1) and the cyclic compound of Formula (2) is within the ranges, a lithium secondary battery having the electrolyte solution tends to have more excellent energy density and/or cycle characteristics.

In addition, from the same viewpoint as above, in the electrolyte solution, the content of the cyclic compound of Formula (1) is preferably 5% by volume or more and 55% by volume or less, more preferably 10% by volume or more and 55% by volume or less, still more preferably 15% by volume or more and 50% by volume or less, even still more preferably 20% by volume or more and 45% by volume or less, and particularly preferably 25% by volume or more and 40% by volume or less.

Furthermore, from the same viewpoint as above, in the electrolyte solution, the content of the cyclic compound of Formula (2) is preferably 1% by volume or more and 50% by volume or less, more preferably 3% by volume or more and 40% by volume or less, still more preferably 5% by volume or more and 30% by volume or less, and even still more preferably 8% by volume or more and 20% by volume or less.

### (Hydrofluoroether)

The electrolyte solution according to the present embodiment includes a hydrofluoroether (hereinafter also referred to as an “HFE”). The HFE may be used alone or in combination of two or more kinds thereof. In addition, in the present specification, the “hydrofluoroether (HFE)” means an ether compound having at least one fluorine atom and hydrogen atoms (preferably an ether compound consisting of only hydrogen atoms, fluorine atoms, oxygen atoms, and carbon atoms).

A molecular weight of the hydrofluoroether (HFE) included in the electrolyte solution of the present embodiment is not particularly limited, and is, for example, 100 or more and 500 or less. From the viewpoint of further improving the stability of the lithium secondary battery against changes in environmental temperature, the molecular weight of the HFE is preferably 120 or more and 450 or less, more preferably 140 or more and 400 or less, still more preferably 160 or more and 350 or less, and even still more preferably 180 or more and 300 or less.

The number of carbon atoms in the HFE is not particularly limited, and is, for example, 3 or more and 30 or less. In addition, from the viewpoint of improving the cycle characteristics and/or the stability of the battery, the number of carbon atoms in the HFE is preferably 4 or more, 5 or more, or 6 or more, and from the same viewpoint, the number of carbon atoms in the HFE is preferably 25 or less, 20 or less, 15 or less, or 10 or less.

It is preferable that the HFE included in the electrolyte solution is a chain-like fluorine compound having at least one of a monovalent group represented by Formula (A) or a monovalent group represented by Formula (B). In a case where an electrolyte solution including such an HFE is used, the cycle characteristics of the battery tend to be further improved. In addition, from such a viewpoint, it is preferable that the HFE included in the electrolyte solution has Formula (A). Furthermore, in Formulae (A) and (B), a wavy line represents a bonding site in the monovalent group.

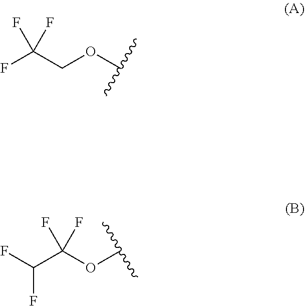 [SMILES: *OCC(F)(F)F ; *OC(F)(F)C(F)F]

In a case where the HFE included in the electrolyte solution of the present embodiment has at least one of the structures represented by Formula (A) or (B), the HFE is more preferably a compound represented by Formula (A′) or (B′). In a case where an electrolyte solution including such an HFE is used, the cycle characteristics of the battery tend to be further improved. Furthermore, in Formula (A′), R¹ is a fluorinated saturated or unsaturated monovalent hydrocarbon group which may be fluorinated, and in Formula (B′), R² is a hydrogen atom or an alkyl group, RF is a saturated or unsaturated monovalent hydrocarbon group having a fluorine atom, and m is an integer of 1 or more and 5 or less.

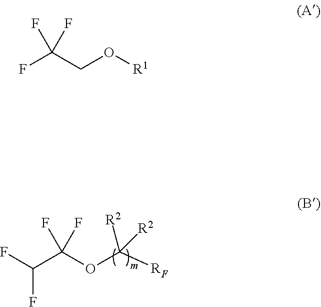

In Formula (A′) of the HFE, R¹ is not particularly limited as long as it is a saturated or unsaturated monovalent hydrocarbon group which may be fluorinated, and is, for example, a linear or branched alkyl group, alkenyl group, or alkynyl group having 1 to 5 carbon atoms, which may have a fluorine atom. R¹ is preferably a linear or branched alkyl group having 1 to 3 carbon atoms, which has at least one fluorine atom. In addition, the number of fluorine atoms in R¹ is not particularly limited, and is, for example, 0 or more and 10 or less, preferably 1 or more and 6 or less, and more preferably 2 or more and 5 or less.

From the viewpoint of further improving the effect of the electrolyte solution of the present embodiment, R¹ is preferably a fluorinated methyl group or a fluorinated ethyl group, more preferably a trifluoromethyl group, a trifluoroethyl group, a tetrafluoroethyl group, or a pentafluoroethyl group, and still more preferably a 1,1,2,2-tetrafluoroethyl group.

In Formula (B′) of the HFE, R² is not particularly limited as long as it is a hydrogen atom or an alkyl group. In a case where R² is an alkyl group, the number of carbon atoms is not particularly limited, and is, for example, 1 or more and 5 or less, preferably 1 or more and 3 or less, and more preferably 1 or 2. From the viewpoint of further improving the effect of the present embodiment by the electrolyte solution, it is preferable that R² represents the hydrogen atom.

In Formula (B′) of the HFE, m is not particularly limited as long as it is an integer of 1 or more and 5 or less. From the viewpoint of further improving the effect of the present embodiment by the electrolyte solution, m is preferably 1 or more and 4 or less, more preferably 1 or more and 3 or less, and still more preferably 1 or more and 2 or less.

In Formula (B′) of the HFE, RF is not particularly limited as long as it is a saturated or unsaturated monovalent hydrocarbon group which may be fluorinated, and is, for example, a linear or branched alkyl group, alkenyl group, or alkynyl group having 1 or more and 5 or less carbon atoms, which has at least one fluorine atom. RF is preferably a linear or branched alkyl group having 1 or more and 5 or less carbon atoms, which has at least one fluorine atom, and more preferably a linear or branched alkyl group having 1 or more and 3 or less carbon atoms, which has at least one fluorine atom. The number of fluorine atoms in RF is not particularly limited as long as it is 1 or more, and is, for example, 1 or more and 10 or less, preferably 1 or more and 5 or less and more preferably 2 or more and 4 or less.

The HFE included in the electrolyte solution of the present embodiment is not particularly limited, and examples thereof include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,1,2,2-tetrafluoroethyl-2,2,2-trifluoroethyl ether, ethyl-1, 1,2,2-tetrafluoroethyl ether, methyl-1, 1,2,2-tetrafluoroethyl ether, 1H, 1H,5H-octafluoropentyl-1,1,2,2-tetrafluoroethyl ether, difluoromethyl-2,2,3,3-tetrafluoropropyl ether, methyl perfluorobutyl ether, and ethyl perfluorobutyl ether. From the viewpoint of further improving the cycle characteristics of a lithium secondary battery having the electrolyte solution of the present embodiment, 1,1,2,2-tetrafluoroethyl-2,2,2-trifluoroethyl ether or 1,1,2,2-tetrafluoroethyl-2,2,3,3-tetrafluoropropyl ether is preferable as HFE.

In addition, HFE may be used alone or in combination with two or more kinds thereof.

A content of the HFE included in the electrolyte solution is, for example, 5.0% by volume or more and 80% by volume or less with respect to a total amount of the solvent components of the electrolyte solution. The content of the HFE is preferably 5.0% by volume or more and 70% by volume or less, more preferably 10% by volume or more and 65% by volume or less, still more preferably 15% by volume or more and 60% by volume or less, even still more preferably 20% by volume or more and 55% by volume or less, and particularly preferably 25% by volume or more and 50% by volume or less. In a case where the content of the HFE is within the ranges, a lithium secondary battery having the electrolyte solution tends to have more excellent cycle characteristics.

### (Ether not Having Fluorine Atom)

The electrolyte solution according to the present embodiment includes an ether not having a fluorine atom (hereinafter also referred to as a “non-fluorinated ether”).

The number of carbon atoms in the non-fluorinated ether in the electrolyte solution of the present embodiment is not particularly limited, and is, for example, 2 or more and 20 or less. From the viewpoint of further improving the effect of the present embodiment by the electrolyte solution, the number of carbon atoms in the non-fluorinated ether is preferably 3 or more and 15 or less, more preferably 4 or more and 12 or less, and still more preferably 5 or more and 10 or less.

The number of ether bonds in the non-fluorinated ether is not particularly limited, and is, for example, 1 or more and 10 or less. From the viewpoint of further improving the solubility of the electrolyte in the electrolyte solution, the number of ether bonds in the non-fluorinated ether is preferably 2 or more or 3 or more. In addition, the number of ether bonds in the non-fluorinated ether is preferably 8 or less, or 5 or less.

The non-fluorinated ether may be a saturated ether compound or an unsaturated ether compound. From the viewpoint of further improving the effect of the present embodiment by the electrolyte solution, it is preferable that the electrolyte solution includes a saturated non-fluorinated ether.

The non-fluorinated ether included in the electrolyte solution of the present embodiment is not particularly limited, and examples thereof include 1,2-dimethoxyethane (DME), 1,2-dimethoxypropane (DMP), diethylene glycol dimethyl ether, triethylene glycol dimethyl ether, tetraethylene glycol dimethyl ether, 1,3-dimethoxypropane, 1,4-dimethoxybutane, 1,1-dimethoxyethane, 2,2-dimethoxypropane, 1,3-dimethoxybutane, 1,2-dimethoxybutane, 2,2-dimethoxybutane, 2,3-dimethoxybutane, 1,2-diethoxypropane, 1,2-diethoxybutane, 2,3-diethoxybutane, and diethoxyethane. From the viewpoint of further improving the effect of the present embodiment by the electrolyte solution, the non-fluorinated ether is preferably 1,2-dimethoxyethane, 1,2-dimethoxypropane, or a mixture thereof, and more preferably 1,2-dimethoxyethane or 1,2-dimethoxypropane.

In addition, the non-fluorinated ether may be used alone or in combination with two or more kinds thereof.

A content of the non-fluorinated ether in the electrolyte solution is not particularly limited, and is, for example, 1.0% by volume or more and 70% by volume or less with respect to the total amount of the solvent components of the electrolyte solution. The content of the non-fluorinated ether is preferably 5.0% by volume or more and 65% by volume or less, more preferably 10% by volume or more and 60% by volume or less, still more preferably 15% by volume or more and 55% by volume or less, and even still more preferably 20% by volume or more and 50% by volume or less. In a case where the content of the non-fluorinated ether is within the ranges, a lithium secondary battery having the electrolyte solution tends to have more excellent cycle characteristics.

### (Other Solvents)

The electrolyte solution of the present embodiment may further include solvents other than the cyclic compound of Formula (1) or Formula (2), the HFE, and the non-fluorinated ether. That is, the electrolyte solution of the present embodiment may include, for example, a heterocyclic compound other than the cyclic compound represented by Formula (1) or Formula (2), and may include, for example, a carbonyl compound having no fluorine atom other than the above-described ether compound.

A content of the solvents other than the cyclic compound of Formula (1) or Formula (2), the HFE, and the non-fluorinated ether in the electrolyte solution is not particularly limited, and is, for example, 0.0% by volume or more and 30% by volume or less, or 1.0% by volume or more and 25% by volume or less. From the viewpoint of improving the effect of the present embodiment by the electrolyte solution, the content of such other solvents is preferably 0.0% by volume or more and 10% by volume or less, and more preferably 0% by volume or more and 5.0% by volume or less.

A volume ratio of the content of the cyclic compound of Formula (1) or Formula (2) to HFE is not particularly limited, and is, for example, 0.2 or more and 2.0 or less. From the viewpoint of improving the effect of the present embodiment by the electrolyte solution, the volume ratio of the content of the cyclic compound of Formula (1) or Formula (2) to HFE is preferably 0.3 or more and 1.8 or less, more preferably 0.4 or more and 1.7 or less, still more preferably 0.5 or more and 1.6 or less, and even still more preferably 0.6 or more and 1.4 or less.

In addition, the volume ratio of the content of the cyclic compound of Formula (1) or Formula (2) to the non-fluorinated ether is not particularly limited, and is, for example, 0.2 or more and 3.0 or less. From the viewpoint of improving the effect of the present embodiment by the electrolyte solution, the volume ratio of the content of the cyclic compound of Formula (1) or Formula (2) to the non-fluorinated ether is preferably 0.3 or more and 2.7 or less, more preferably 0.4 or more and 2.5 or less, and still more preferably 0.5 or more and 2.0 or less.

Furthermore, the volume ratio of the content of the HFE to the non-fluorinated ether is not particularly limited, and is, for example, 0.2 or more and 3.0 or less. From the viewpoint of improving the effect of the present embodiment by the electrolyte solution, the volume ratio of the content of the HFE to the non-fluorinated ether is preferably 0.3 or more and 2.8 or less, more preferably 0.4 or more and 2.6 or less, and still more preferably 0.5 or more and 2.5 or less.

### (Lithium Salts)

The lithium salts included in the electrolyte solution are not particularly limited, and examples thereof include inorganic salts and organic salts of lithium. Specific examples thereof include LiI, LiCl, LiBr, LiF, LiBF₄, LiPF₆, LiPF₂O₂, LiPF₂(C₂O₄)₂, LiPF₂(C₃O₄)₂, LiAsF₆, LiSO₃CF₃, LiN(SO₂F)₂, LiN(SO₂CF₃)₂, LiN(SO₂CF₂CF₃)₂, LiBF₂(C₂O₄), LiB(C₂O₄)₂, LiB(O₂C₂H₄)₂, LiB(C₃O₄)₂, LiB(O₂C₂H₄)F₂, LiB(OCOCF₃)₄, LiNO₃, and Li₂SO₄. From the viewpoint that the energy density and/or the cycle characteristics of a lithium secondary battery using the electrolyte solution of the present embodiment are more excellent, it is preferable that the lithium salts include at least LiN(SO₂F)₂. Furthermore, the lithium salts may be used alone or in combination of two or more kinds thereof.

The electrolyte solution may further include a salt other than the lithium salt as the electrolyte. Examples of such a salt include salts of Na, K, Ca, and Mg.

A total concentration of the lithium salts in the electrolyte solution is not particularly limited, and is preferably 0.30 M or more, more preferably 0.40 M or more, still more preferably 0.50 M or more, and even still more preferably 0.80 M or more. In a case where the concentration of the lithium salts is within the ranges, the SEI layer is more easily formed and the internal resistance tends to be further lowered. In particular, in a lithium secondary battery including a fluorine compound as the solvent, the concentration of the lithium salts in the electrolyte solution can be increased, and therefore, the cycle characteristics and the rate performance can be further improved. An upper limit of the concentration of the lithium salts is not particularly limited, and the concentration of the lithium salts may be 10.0 M or less, 5.0 M or less, or 2.0 M or less.

A specific gravity of the electrolyte solution of the present embodiment is preferably 1.0 g/cc or more and 1.3 g/cc or less. In a case where the specific gravity of the electrolyte solution is within the ranges, the energy density of the lithium secondary battery using the electrolyte solution is improved. From the same viewpoint, the specific gravity of the electrolyte solution is more preferably 1.05 g/cc or more and 1.25 g/cc or less, and still more preferably 1.1 g/cc or more and 1.2 g/cc or less.

The cyclic compound of Formula (1) or Formula (2) included in the electrolyte solution tends to have a higher boiling point than a compound generally used as the solvent of the electrolyte solution. The high boiling point of the cyclic compound of Formula (1) or Formula (2) tends to further improve the stability of the electrolyte solution with respect to changes in environmental temperature and to improve the cycle characteristics. From such a viewpoint, the boiling point of the electrolyte solution of the present embodiment is preferably 72° C. or higher, more preferably 80° C. or higher, and still more preferably 85° C. or higher at atmospheric pressure.

Furthermore, the presence of the cyclic compound of Formula (1) or Formula (2), the HFE, the non-fluorinated ether, and the like included in the electrolyte solution can be confirmed by estimating the molecular structure through measurement or analysis using a known method. Examples of such a method include a method using NMR, mass spectrometry, elemental analysis, and infrared spectroscopy. In addition, the molecular structure of the solvent can be estimated by theoretical calculation using a molecular dynamics method, a molecular orbital method, or the like.

### (Method for Preparing Electrolyte Solution)

In the preparation of the electrolyte solution of the present embodiment, the electrolyte solution can be prepared by using a solution obtained by mixing, as a solvent, the cyclic compound of Formula (1) or Formula (2), the HFE, the non-fluorinated ether, and as necessary, a solvent other than the solvents, and dissolving at least one of the lithium salts in the solution. A mixing ratio of the solvent and the lithium salts may be appropriately adjusted such that the kind, the content, the concentration, and the like of each of the solvent and the lithium salts are within the above-described ranges.

### (Lithium Secondary Battery)

The lithium secondary battery of the present embodiment includes the above-described electrolyte solution. By configuring the above-described electrolyte solution to include the lithium secondary battery, the electrolyte solution is excellent in both the energy density and the cycle characteristics.

The type of the lithium secondary battery is not particularly limited as long as charge/discharge of the battery are performed by an oxidation-reduction reaction of lithium and the battery has an electrolyte solution. Examples of the lithium secondary battery include a lithium-ion battery, a lithium-metal battery, an anode-free lithium secondary battery, a lithium-sulfur battery, a lithium-oxygen battery, and a lithium-air battery. From the viewpoint of further improving the effect of the electrolyte solution of the present embodiment, the lithium secondary battery is preferably the anode-free lithium secondary battery or the lithium-metal battery, and more preferably the anode-free lithium secondary battery.

In the lithium secondary battery according to one embodiment of the present invention, it is preferable that lithium metal is deposited on a surface of the negative electrode and the deposited lithium metal is dissolved to perform charge/discharge. Examples of such a lithium secondary battery include an anode-free lithium secondary battery and a lithium-metal battery. According to such an aspect, the lithium secondary battery tends to further improve the effect of the electrolyte solution.

Hereinafter, the details of various lithium secondary batteries will be described.

### [Anode-Free Battery]

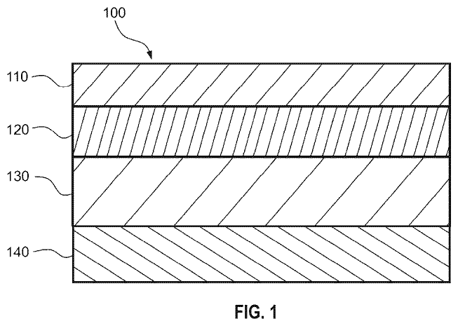

FIG. 1 is a schematic cross-sectional view of an anode-free battery according to the present embodiment. As illustrated in FIG. 1, an anode-free battery 100 of the present embodiment includes a positive electrode 120, a negative electrode 140 not having a negative-electrode active material, a separator 130 placed between the positive electrode 120 and the negative electrode 140, and an electrolyte solution that is not illustrated in FIG. 1. The positive electrode 120 has a positive electrode current collector 110 on the surface thereof opposite to the surface facing the separator 130.

Hereinafter, each configuration of the anode-free battery 100 will be described.

In the anode-free lithium secondary battery (hereinafter also referred to as an “anode-free battery” or an “AFB”) of the present embodiment, the negative electrode consists of a negative electrode current collector not having a negative-electrode active material, and the above-described electrolyte solution is used as an electrolyte solution. The negative-electrode active material is a substance that causes an electrode reaction, that is, an oxidation reaction and a reduction reaction in the negative electrode. Specifically, examples of the negative-electrode active material of the present embodiment include lithium metal and a host material for a lithium element (lithium ions or lithium metal). The host material for the lithium element means a material provided to retain the lithium ions or the lithium metal in the negative electrode. Examples of such a retention mechanism include intercalation, alloying, and occlusion of metal clusters, and the intercalation is typically used.

In the anode-free battery, before the initial charge of the battery, the negative electrode does not have a negative-electrode active material and consists of only a negative electrode current collector. Therefore, after the initial charge, lithium metal is deposited on the negative electrode and the deposited lithium metal is electrolytically dissolved to perform charge/discharge. Therefore, the anode-free battery has an advantage that a volume occupied by the negative-electrode active material and a mass of the negative-electrode active material are reduced, and the volume and the mass of the entire battery are small, leading to a high energy density in principle.

It is preferable that the lithium secondary battery according to one embodiment of the present invention includes a negative electrode consisting of a negative electrode current collector not having a negative-electrode active material. Examples of such a lithium secondary battery include the anode-free battery of the present embodiment. According to the aspect, the lithium secondary battery exerts a synergistic effect with the electrolyte solution of the present embodiment, and tends to further improve the effect according to the present embodiment.

In the anode-free battery of the present specification, the negative electrode “not having a negative-electrode active material” as used herein means the negative electrode does not have the negative-electrode active material or does not substantially have the negative-electrode active material. The fact that the negative electrode does not substantially have the negative-electrode active material means the content of the negative-electrode active material in the negative electrode is 10% by mass or less with respect to the total amount of the negative electrode. The content of the negative-electrode active material in the negative electrode of the anode-free battery is preferably 5.0% by mass or less and it may be 1.0% by mass or less, 0.1% by mass or less, or 0.0% by mass or less, each with respect to the total amount of the negative electrode. By configuring the negative electrode not to have a negative-electrode active material or configuring the content of the negative-electrode active material in the negative electrode to be within the ranges, a high energy density of the lithium secondary battery is obtained.

In addition, in the anode-free battery of the present specification, the “before the initial charge” of the battery means a state from the time when the battery is assembled to the time when the battery is first charged. In addition, “at the end of discharge” of the battery means a state where the battery voltage is 1.0 V or more and 3.8 V or less, and preferably 1.0 V or more and 3.0 V or less.

In the anode-free battery of the present embodiment, in a case where the battery voltage is 1.0 V or more and 3.5 V or less, the content of the lithium metal may be 10% by mass or less (which is preferably 5.0% by mass or less, and may be 1.0% by mass or less) with respect to the total amount of the negative electrode; in a case where the battery voltage is 1.0 V or more and 3.0 V or less, the content of the lithium metal may be 10% by mass or less (which is preferably 5.0% by mass or less, and may be 1.0% by mass or less) with respect to the total amount of the negative electrode; or in a case where the battery voltage is 1.0 V or more and 2.5 V or less, the content of the lithium metal may be 10% by mass or less (which is preferably 5.0% by mass or less, and may be 1.0% by mass or less) with respect to the total amount of the negative electrode.

In addition, in the anode-free battery of the present embodiment, a ratio M_{3.0}/M_{4.2} of a mass M_{3.0} of the lithium metal deposited on the negative electrode in a state where the battery voltage is 3.0 V to a mass M_{4.2} of the lithium metal deposited on the negative electrode in a state where the battery voltage is 4.2 V is preferably 40% or less, more preferably 38% or less, and still more preferably 35% or less. The ratio M_{3.0}/M_{4.2} may be 1.0% or more, 2.0% or more, 3.0% or more, or 4.0% or more.

Moreover, examples of the negative-electrode active material include lithium metal and an alloy including the lithium metal, a carbon-based material, metal oxides, and metal to be alloyed with lithium and an alloy including the metal. The carbon-based material is not particularly limited, and examples thereof include graphene, graphite, hard carbon, and carbon nanotubes. The metal oxide is not particularly limited, and examples thereof include titanium oxide-based compounds and cobalt oxide-based compounds. Examples of the metal to be alloyed with lithium include silicon, germanium, tin, lead, aluminum, and gallium.

The negative electrode of the anode-free battery is not particularly limited as long as it does not have a negative-electrode active material and can be used as a current collector. Examples of the negative electrode include negative electrodes consisting of at least one selected from the group consisting of metals such as Cu, Ni, Ti, Fe, and other metals that do not react with Li, alloys of these metals, and stainless steel (SUS), and preferred examples of the negative electrode include negative electrodes consisting of at least one selected from the group consisting of Cu, Ni, alloys of these metals, and stainless steel (SUS). In a case where such a negative electrode is used, the energy density and the productivity of the battery tend to be further improved. These negative electrode materials may be used alone or in combination of two or more kinds thereof. Furthermore, the phrase of “metal that does not react with Li” in the present specification means metal which does not form an alloy by reaction with lithium ions or lithium metal under the operation conditions of a lithium secondary battery.

An average thickness of the negative electrode of the anode-free battery is not particularly limited, and is, for example, 3.0 μm or more and 30 μm or less. From the viewpoint of reducing the volume occupied by the negative electrode in the anode-free battery and improving the energy density, the average thickness of the negative electrode is preferably 4.0 μm or more and 20 μm or less, more preferably 5.0 μm or more and 18 μm or less, and still more preferably 6.0 μm or more and 15 μm or less.

At least a part of a surface of the negative electrode of the anode-free battery, facing the positive electrode, may be coated with a compound (hereinafter also referred to as a “negative electrode coating agent”) including an aromatic ring to which two or more elements selected from the group consisting of N, S, and O are each independently bonded. It is presumed that the negative electrode coating agent can be retained on the negative electrode by configuring at least one element selected from the group consisting of N, S, and O to be coordinately bonded to a metal atom constituting the negative electrode. In addition, in a case where the negative electrode coated with the negative electrode coating agent is used, it can be expected that a non-uniform deposition reaction of the lithium metal is suppressed on the surface of the negative electrode and the growth of lithium metal deposited on the negative electrode into a dendrite shape is suppressed.

The negative electrode coating agent is not particularly limited as long as it is a compound including an aromatic ring in which two or more elements selected from the group consisting of N, S, and O are each independently bonded, that is, a compound having a structure in which two or more of N, S, and O are independently bonded to an aromatic ring. Examples of the aromatic ring include aromatic hydrocarbons such as benzene, naphthalene, azulene, anthracene, and pyrene, and heteroaromatic compounds such as furan, thiophene, pyrrole, imidazole, pyrazole, pyridine, pyridazine, pyrimidine, and pyrazine. Among these, the aromatic hydrocarbons are preferable, benzene or naphthalene is more preferable, and benzene is still more preferable.

In addition, it is preferable that one or more nitrogen atoms are bonded to the aromatic ring in the negative electrode coating agent. Furthermore, it is more preferable that the negative electrode coating agent is a compound having a structure in which a nitrogen atom is bonded to the aromatic ring, and in addition to the nitrogen atom, one or more elements selected from the group consisting of N, S, and O are each independently bonded to the aromatic ring. In a case where the compound in which a nitrogen atom is bonded to the aromatic ring is used as the negative electrode coating agent in this manner, the cycle characteristics of the battery tend to be further improved.

Specific examples of the negative electrode coating agent include at least one selected from the group consisting of benzotriazole, benzimidazole, benzimidazolethiol, benzoxazole, benzothiazolethiol, benzothiazole, mercaptobenzothiazole, and derivatives thereof. Among these, as the negative electrode coating agent, at least one selected from the group consisting of benzotriazole, benzimidazole, benzoxazole, mercaptobenzothiazole, and derivatives thereof is preferable. According to such an aspect, electrical connection between the negative electrode and the lithium ions with which the negative electrode coating agent is coordinated is further improved, and thus, the cycle characteristics of the battery tend to be further improved.

At least a part of the surface of the negative electrode facing the positive electrode may be coated with the negative electrode coating agent. That is, in the surface of the negative electrode, 10% or more of the surface area, in terms of the area ratio, only needs to have the negative electrode coating agent, and preferably 20% or more, more preferably 40% or more, still more preferably 60% or more, and even still more preferably 80% or more of the surface area may have the negative electrode coating agent.

A separator of the anode-free battery is not particularly limited as long as it has a function of physically and/or electrically separating the positive electrode and the negative electrode from each other, and a function of securing the ion conductivity of lithium ions. Examples of such a separator include a porous member having insulating properties, a polymer electrolyte, a gel electrolyte, and an inorganic solid electrolyte, and typically include at least one selected from the group consisting of the porous member having insulating properties, the polymer electrolyte, and the gel electrolyte. In addition, as the separator, a member may be used alone or members may be used in combination of two or more kinds thereof.

As the separator of the anode-free battery, the porous insulating member, the polymer electrolyte, or the gel electrolyte may be used alone or in combination of two or more kinds thereof. Furthermore, in a case where the porous insulating member is used alone as the separator, the lithium secondary battery needs to further include an electrolyte solution.

In a case where the separator includes the porous insulating member, the member exhibits ionic conductivity by filling pores of the member with a material having ionic conductivity. Therefore, in the present embodiment, for example, the electrolyte solution of the present embodiment, the gel electrolyte including the electrolyte solution of the present embodiment, and the like are filled.

A material constituting the porous insulating member is not particularly limited, and examples thereof include an insulating polymer material, and specifically include polyethylene (PE) and polypropylene (PP). That is, the separator may be a porous polyethylene (PE) film, a porous polypropylene (PP) film, or a laminated structure thereof.

The separator may be covered (coated) with a separator coating layer. The coating layer may cover both surfaces of the separator or may cover only one of the surfaces. From the viewpoint of improving the cycle characteristics of the lithium secondary battery in the present embodiment, it is preferable that both surfaces of the separator are covered. The separator coating layer in the present embodiment is a film-like coating layer that is uniformly continuous, and is, for example, a film-like coating layer that is uniformly continuous over an area of 50% or more of the surface of the separator.

The separator coating layer is not particularly limited, and for example, a binder such as polyvinylidene fluoride (PVDF), a composite material (SBR-CMC) of styrene butadiene rubber and carboxymethyl cellulose, or a polyacrylic acid (PAA) is preferable. In the separator coating layer, inorganic particles such as silica, alumina, titania, zirconia, and magnesium hydroxide may be added to the binder.

An average thickness of the separator, including the separator coating layer, is not particularly limited, and is, for example, 3.0 μm or more and 40 μm or less. In the lithium secondary battery, from the viewpoint of securely separating the positive electrode and the negative electrode from each other and reducing a volume occupied by the separator in the battery, the average thickness of the separator is preferably 5.0 μm or more and 30 μm or less, more preferably 7.0 μm or more and 10 μm or less, and still more preferably 10 μm or more and 20 μm or less.

The positive electrode of the anode-free battery is not particularly limited as long as it is a positive electrode generally used for a lithium secondary battery, and known materials can be appropriately selected depending on the use of the lithium secondary battery. From the viewpoint of improving the stability and the output voltage of the battery, it is preferable that the positive electrode has a positive-electrode active material. In a case where the positive electrode has a positive-electrode active material, typically, lithium ions are filled into and extracted from the positive-electrode active material by the charge/discharge of the battery. Furthermore, in the present specification, the term “positive-electrode active material” is a substance that causes an electrode reaction, that is, an oxidation reaction and a reduction reaction in the positive electrode, and specific examples of the positive-electrode active material include a host material of a lithium element (typically, a lithium ion).

Such a positive-electrode active material is not particularly limited, and examples thereof include metal oxides and metal phosphates. The metal oxides are not particularly limited, and examples thereof include cobalt oxide-based compounds, manganese oxide-based compounds, and nickel oxide-based compounds. The metal phosphates are not particularly limited, and examples thereof include iron phosphate-based compounds and cobalt phosphate-based compounds. Examples of typical positive-electrode active materials include LiCoO₂, LiNiₓCo_{y}Mn_{z}O (x+y+z=1), LiNiₓCo_{y}Al_{z}O (x+y+z=1), LiNiₓMn_{y}O (x+y=1), LiNiO₂, LiMn₂O₄, LiFePO, LiCoPO, LiFeOF, LiNiOF, and LiTiS₂. The positive-electrode active materials may be used alone or in combination of two or more kinds thereof.

The positive electrode may include components other than the positive-electrode active material. Such a component is not particularly limited, and examples thereof include a sacrificial positive electrode material, a conductive aid, a binder, a gel electrolyte, and a polymer electrolyte.

Here, the sacrificial positive electrode material is a lithium-containing compound that causes an oxidation reaction in a charge/discharge potential range of the positive-electrode active material and does not substantially cause a reduction reaction, and in particular, the positive electrode may include the sacrificial positive electrode in an anode-free battery.

In particular, the positive electrode may include a gel electrolyte. According to such an aspect, adhesion force between the positive electrode and the positive electrode current collector is improved by a function of the gel electrolyte, and it is possible to attach a thinner positive electrode current collector, and thus, it is possible to further improve the energy density of the battery. In a case of attaching the positive electrode current collector to a surface of the positive electrode, a positive electrode current collector formed on a release paper may be used.

The conductive aid in the positive electrode is not particularly limited, and examples thereof include carbon black, single-wall carbon nanotubes (SWCNT), multi-wall carbon nanotubes (MWCNT), and carbon nanofibers (CF). In addition, the binder is not particularly limited, and examples thereof include polyvinylidene fluoride, polytetrafluoroethylene, styrene butadiene rubber, acrylic resins, and polyimide resins.

The gel electrolyte is not particularly limited, and examples thereof include a polymer, an organic solvent, and a lithium salt. The polymer in the gel electrolyte is not particularly limited, and examples thereof include a copolymer of polyethylene and/or polyethylene oxide, polyvinylidene fluoride, and a copolymer of polyvinylidene fluoride and hexafluoropropylene. In addition, the polymer electrolyte is not particularly limited, and examples thereof include a solid polymer electrolyte mainly including a polymer and an electrolyte and a semi-solid polymer electrolyte mainly including a polymer, an electrolyte, and a plasticizer.

An average thickness of the positive electrode is preferably 20 μm or more and 100 μm or less, more preferably 30 μm or more and 80 μm or less, and still more preferably 40 μm or more and 70 μm or less. However, the average thickness of the positive electrode can be appropriately adjusted according to a desired capacity of the battery.

A positive electrode current collector is disposed on one side of the positive electrode of the anode-free battery. The positive electrode current collector is not particularly limited as long as it is a conductor not reactive with lithium ions in the battery. Examples of such a positive electrode current collector include aluminum. Furthermore, the positive electrode current collector may not be provided, and in this case, the positive electrode itself acts as a current collector. Herein, the positive electrode current collector functions to transfer electrons to and from the positive electrode (in particular, the positive-electrode active material), and is in physical and/or electrical contact with the positive electrode.

In the anode-free battery, an average thickness of the positive electrode current collector is preferably 1.0 μm or more and 15 μm or less, more preferably 2.0 μm or more and 10 μm or less, and still more preferably 3.0 μm or more and 6.0 μm or less. According to such an aspect, the volume occupied by the positive electrode current collector in the anode-free battery is reduced, and therefore, the energy density of the anode-free battery is further improved.

One use aspect of the lithium secondary battery, including an anode-free battery, will be described. In one use aspect of the lithium secondary battery, a positive electrode terminal and a negative electrode terminal for connecting the battery to an external circuit are joined to the positive electrode current collector and the negative electrode, respectively. In the lithium secondary battery, the negative electrode terminal is connected to one end of an external circuit and the positive electrode terminal is connected to the other end of the external circuit to perform charge/discharge.

In the positive electrode terminal and the negative electrode terminal, the lithium secondary battery is charged by applying a voltage to cause a current to flow from the negative electrode terminal (negative electrode) to the positive electrode terminal (positive electrode) through the external circuit. In the lithium secondary battery after the charge, the positive electrode terminal and the negative electrode terminal are connected through a desired external circuit, thus discharging the lithium secondary battery.

In the anode-free battery, it is presumed that the solid electrolyte interfacial layer (SEI layer) is formed on the surface of the negative electrode (at the interface between the negative electrode and the separator) by the initial charge, but the battery may not have the SEI layer. By charging the anode-free battery, the deposition of the lithium metal generated at an interface between the negative electrode and the SEI layer, at an interface between the negative electrode and the separator, and/or at an interface between the SEI layer and the separator. In addition, in the anode-free battery, the deposition of the lithium metal generated on the negative electrode is electrolytically dissolved by discharge. In a case where the SEI layer is formed in the battery, the deposition of the lithium metal generated at least at the interface between the negative electrode and the SEI layer and/or the interface between the SEI layer and the separator is electrolytically dissolved.

The method for producing an anode-free battery is not particularly limited as long as it can produce a lithium secondary battery including the above-described configuration, and examples of the method include the following methods.

The positive electrode current collector and the positive electrode of the anode-free battery are produced, for example, as follows. The above-described positive-electrode active material, conductive aid, and binder are mixed to obtain a positive electrode mixture. The mixing ratio may be, for example, 50% by mass or more and 99% by mass or less of the positive-electrode active material, 0.5% by mass or more and 30% by mass or less of the conductive aid and 0.5% by mass or more and 30% by mass or less of the binder with respect to the total amount of the positive electrode mixture. The obtained positive electrode mixture is applied onto one of the surfaces of a metal foil (for example, Al foil) serving as a positive electrode current collector and having a predetermined thickness (for example, 5.0 μm or more and 1.0 mm or less), followed by press molding. The obtained molded product is punched into a predetermined size to obtain a positive electrode current collector and a positive electrode.

Next, the above-described negative electrode material of the anode-free battery, for example, a metal foil (such as an electrolytic Cu foil) having a thickness of 1.0 μm or more and 1.0 mm or less is washed with a sulfamic-acid-containing solvent, punched into a predetermined size, ultrasonically washed with ethanol, and then dried to obtain a negative electrode.

Next, a separator having the above-described configuration is prepared. The separator may be produced by a method known in the related art or a commercially available separator may be used. In addition, a functional buffer layer, which is in a fibrous or porous form and has a function of mitigating volume expansion and contraction accompanied by dissolution and deposition of the lithium metal, may be provided between the separator and the negative electrode. The functional buffer layer preferably has ion conductivity or electrical conductivity, but it may not have either.

Next, the electrolyte solution of the present embodiment is prepared by the above-described preparation method.

The positive electrode current collector on which the positive electrode is formed, the separator, and the negative electrode, obtained as described above, are laminated in this order such that the positive electrode faces the separator to obtain a laminate. The obtained laminate can be encapsulated in a hermetically sealing container together with the electrolyte solution to obtain an anode-free battery. The hermetically sealing container is not particularly limited, and examples include a laminate film.

### [Lithium-Metal Battery]

The lithium-metal battery (hereinafter also referred to as an “LMB”) is produced by using an electrode having lithium metal or a lithium metal alloy on a surface of the electrode or using lithium metal as a negative electrode. The LMB of the present embodiment has the electrolyte solution of the present embodiment. In the same manner as in the anode-free battery, in the LMB, the lithium metal is deposited on a surface of the negative electrode and the deposited lithium is electrolytically dissolved to perform charge/discharge. From the viewpoint of further improving the effect of the present embodiment by the electrolyte solution, in the lithium secondary battery, it is preferable that lithium metal is deposited on a surface of the negative electrode and the deposited lithium metal is dissolved to perform charge/discharge.

On the other hand, as described above, the LMB is different from the anode-free battery in that the negative electrode includes lithium metal as a negative-electrode active material before the initial charge of the battery.

The lithium-metal battery of the present embodiment includes a positive electrode current collector, a positive electrode having a positive-electrode active material disposed on the positive electrode current collector, a negative electrode having lithium metal, facing the positive electrode, and a separator disposed between the positive electrode and the negative electrode. The positive electrode current collector, the positive electrode, the separator, and configurations thereof and preferred aspects thereof are the same as those of the anode-free battery, except as described below.

The negative electrode of the LMB is not particularly limited as long as it includes lithium metal or a lithium metal alloy. Since the negative electrode of the LMB uses lithium metal or a lithium metal alloy having a large specific capacity and a low oxidation-reduction potential, the LMB is generally a battery having a higher energy density than a lithium-ion battery. Examples of such a negative electrode include a lithium metal electrode, an electrode serving as a clad material in which a rolled lithium metal foil is bonded to the surface of a conductive metal foil such as copper, an electrode in which lithium metal is electrochemically deposited on a surface of a metal foil such as copper in advance, and an electrode in which metallic lithium is vacuum-deposited. From the viewpoint of further improving the effect of the present embodiment, an electrode in which a lithium metal foil is bonded onto a surface of conductive metal such as copper, or an electrode in which lithium metal is electrochemically deposited is preferable, and the electrode in which a lithium metal foil is bonded onto a surface of a conductive metal such as copper is more preferable.

An average thickness of the negative electrode of the LMB is not particularly limited, but is, for example, 5.0 μm or more and 100 μm or less. From the viewpoint of improving the capacity and/or the energy density of the battery, the thickness of the battery is preferably 8.0 μm or more and 50 μm or less, more preferably 10 μm or more and 40 μm or less, and still more preferably 10 μm or more and 20 μm or less.

The negative electrode of the LMB may be covered with a negative electrode coating agent in order to suppress dendritic growth of the lithium metal. As the negative electrode coating agent, the same one as that of the above-described anode-free battery can be used.

The LMB may be manufactured using known materials and known manufacturing methods, or may be manufactured in the same manner as the above-described method for manufacturing the anode-free battery, except that lithium metal or a lithium metal alloy is used as the negative electrode.

As one aspect of the lithium-metal battery of the present embodiment, the lithium-metal battery may be a lithium-air battery. In the lithium-air battery, lithium ions in the electrolyte solution are reacted with oxygen to form lithium peroxide during discharge, and the lithium peroxide is decomposed into a lithium ion and oxygen during charging to perform charge/discharge. The lithium-air battery can be manufactured by using a configuration in the related art. For example, it can be manufactured by realizing the positive electrode and the positive electrode current collector so as to take a configuration where the lithium-metal battery has an oxygen-containing gas such as air and oxygen can be used as the positive-electrode active material. Furthermore, for various members such as a positive electrode, a positive electrode current collector, and a conductive agent of the lithium-air battery, known members may be used as members constituting the lithium-air battery.

### [Lithium-Ion Battery]

The lithium-ion battery (hereinafter also referred to as an “LIB”) has a host material for a lithium element (lithium ions or lithium metal) in the negative electrode, this material is filled with the lithium element by the charge of the battery, and the host material releases the lithium element to discharge the battery. The LIB is different from the anode-free battery, particularly in that the negative electrode has the host material of the lithium element.

The lithium-ion battery can be produced using known materials and known production methods. In addition, the electrolyte solution of the present embodiment may be used in an application for exhibiting ion conductivity inside of a lithium-ion battery, and a production stage in which the electrolyte solution is injected, names of members to be included, and the like are not particularly limited.

The shape of the battery included in the lithium secondary battery according to the present embodiment is not particularly limited, and may be, for example, a sheet type, a laminated sheet type, a thin type shape, a bottomed cylindrical type shape, a bottomed prismatic type shape, or the like. From the viewpoint of further enhancing and reliably exhibiting the effect according to the present embodiment, it is preferable that the battery has the sheet type, the laminated sheet type, or the thin type shape.

### EXAMPLES

Hereinafter, the present invention will be described in more detail, using Examples of the present embodiment and Comparative Examples. The present embodiment is not limited in any way by the following Examples.

### Example 1

An anode-free lithium secondary battery (AFB) of Example 1 was manufactured as follows.

### (Preparation of Negative Electrode)

First, an electrolytic Cu foil having a thickness of 4.0 μm was prepared and punched to a predetermined size (105 mm×55 mm).

### (Manufacture of Positive Electrode)

Next, a positive electrode was manufactured. A mixture of 96 parts by mass of LiNi_{0.85}Co_{0.12}Al_{0.03}O₂ as a positive-electrode active material, 2.0 parts by mass of carbon black as a conductive aid, and 2.0 parts by mass of polyvinylidene fluoride (PVDF) as a binder was applied to both surfaces of a 12 μm-thick Al foil and press-molded. The molded product thus obtained was punched to a predetermined size (100 mm×50 mm) to obtain a positive electrode having a positive electrode current collector. In addition, the obtained positive electrode had a unit weight of 21 mg/cm².

### (Preparation of Separator)

A separator obtained by coating 2.0-μm polyvinylidene fluoride (PVDF) on both surfaces of a 12-μm polyethylene microporous membrane and having a predetermined size (108 mm×58 mm) was prepared as the separator.

### (Preparation of Electrolyte Solution)

An electrolyte solution was prepared as follows. Three kinds of solvents, butylbenzene, 1,1,2,2-tetrafluoroethyl-2,2,2-trifluoroethyl ether, and 1,2-dimethoxyethane, were mixed such that the contents of these solvents were each 40% by volume, 40% by volume, and 20% by volume. An electrolyte solution was obtained by dissolving LiN(SO₂F)₂ in the obtained mixed solution such that the molar concentration was 1.0 M.

### (Assembly of Battery)

The punched separator, the positive electrode, and the negative electrode were laminated in the order of separator/negative electrode/separator/positive electrode/separator/ . . . /positive electrode/separator/negative electrode/separator such that the number of positive electrodes, the number of negative electrodes, and the number of separators were 20, 21, and 42, respectively. Thereafter, an aluminum tab having a thickness of 0.2 mm was joined by ultrasonic welding to the uncoated part of the positive-electrode active material of the laminated positive electrode, and a copper/nickel tab was joined to the negative electrode by ultrasonic welding. Then, the injection was continued until the amount of the electrolyte solution reached 14.0 g while the weight was measured with an electronic balance, and vacuum sealing was performed under a reduced pressure of −50 kPa.

### Examples 2 to 13

Lithium secondary batteries were obtained in the same manner as in Example 1, except that the electrolyte solutions were prepared using the solvents and the electrolytes shown in Table 1.

### Comparative Examples 1 to 11

Lithium secondary batteries were obtained in the same manner as in Example 1, except that the electrolyte solutions were prepared using the solvents and the electrolytes described in Table 2. Furthermore, in Comparative Examples, at least one of the cyclic compounds represented by Formula (1) or Formula (2), the hydrofluoroether (HFE), or the ether not having a fluorine atom is not contained.

Moreover, in Table 1, “AC1” represents butylbenzene represented by Formula (3), “AC2” represents isobutylbenzene represented by Formula (4), “AC3” represents tert-butylbenzene represented by Formula (5), “AC4” represents propylbenzene represented by Formula (6), “AC5” represents ethyltoluene represented by Formula (7), “AC6” represents 1,3,5-trimethylbenzene represented by Formula (8), “AC7” represents toluene represented by Formula (9), “HC1” represents cyclohexane represented by Formula (10), “HC2” represents methylcyclohexane represented by Formula (11), “HC3” represents ethylcyclohexane represented by Formula (12), “HFE1” represents 1,1,2,2-tetrafluoroethyl-2,2,2-trifluoroethyl ether represented by Formula (C), “HFE2” represents 1,1,2,2-tetrafluoroethyl-2,2,3,3-tetrafluoropropyl ether represented by Formula (D), “DME” represents 1,2-dimethoxyethane, “DMP” represents 1,2-dimethoxypropane, and “THF” represents tetrahydrofuran. In addition, with regard to the lithium salt used as the electrolyte, “LiFSI” represents LiN(SO₂F)₂.

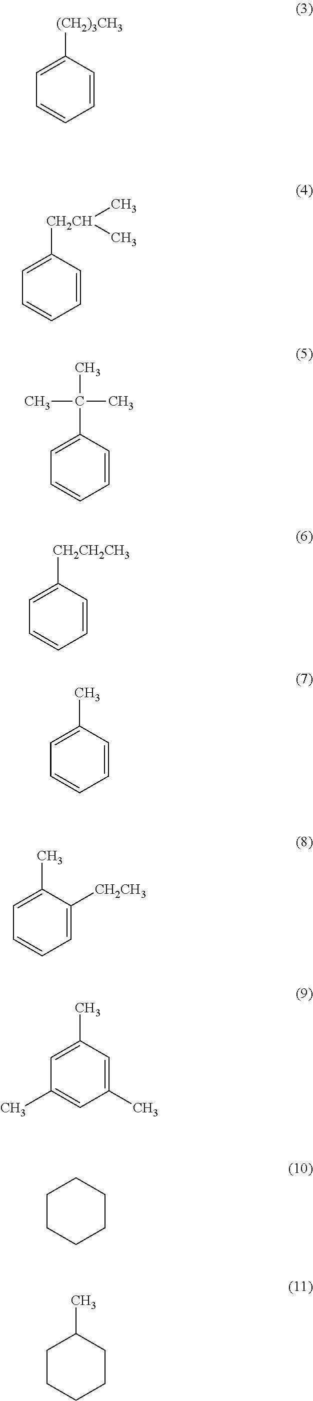

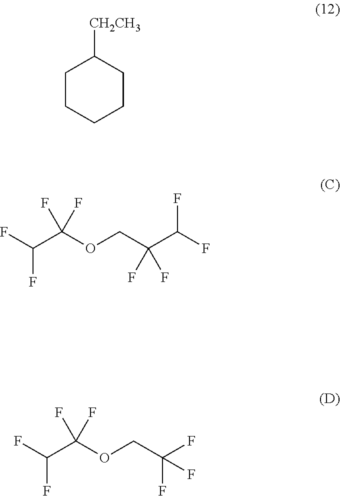 [SMILES: CCC1CCCCC1 ; FC(F)C(F)(F)COC(F)(F)C(F)F ; FC(F)C(F)(F)OCC(F)(F)F]

In Tables 1 and 2, each solvent is classified into any of the cyclic compound of Formula (1) or Formula (2), the HFE, or the non-fluorinated ether as defined above. In addition, in Tables 1 and 2, a numerical value on the right side of each solvent is described as a content with respect to the total amount of solvents in units of % by volume. For example, in Table 1, Example 1 means that AC1 is contained in an amount of 40% by volume, HFE1 is contained in an amount of 40% by volume, DME is contained in an amount of 20% by volume, and 1.0 M LiFSI is contained as an electrolyte.

In addition, in Tables 1 and 2, in each example, in a case where the electrolyte solution includes the cyclic compound of Formula (1) or Formula (2), the number of substituents bonded to the benzene ring of the cyclic compound of Formula (1) or Formula (2) is shown in the column of “Number of substituents (compound of Formula (1) or Formula (2)).” Furthermore, the specific gravity of each of the electrolyte solutions is shown in the column of “Specific gravity of electrolyte solution”.

### [Presence or Absence of Phase Separation]

After preparing the electrolyte solution, the electrolyte solution was allowed to stand for 1 hour in an argon atmosphere, and then the presence or absence of phase separation was visually observed. In Tables 1 and 2, a case where it is determined that phase separation is present is indicated as “Phase separation”.

### [Measurement of Discharge Capacity]

The manufactured lithium secondary battery was CC-charged at 0.8 A until the voltage reached 4.2 V (initial charge), and then CC-discharged at 0.8 A until the voltage reached 3.0 V (which will hereinafter be referred to as “initial discharge”). Next, the lithium secondary battery was CC-charged at 2.4 A until the voltage reached 4.2 V and then CC-discharged at 2.4 A until the voltage reached 3.0 V in an environment of a temperature of 25° C. or 0° C. The discharge capacity at a temperature of 25° C. is shown in Tables 1 and 2.

### [Evaluation of Cycle Characteristics]

The cycle characteristics of each of the lithium secondary batteries manufactured in Examples and Comparative Examples were evaluated as follows.

The manufactured lithium secondary battery was subjected to initial charge and initial discharge. Next, a cycle where the lithium secondary battery was CC-charged at 2.4 A until the voltage reached 4.2 V and then CC-discharged at 2.4 A until the voltage reached 3.0 V was repeated in an environment of a temperature of 25° C. In each example, the capacity was obtained from the initial discharge (which will hereinafter be referred to as an “initial capacity”), and the number of cycles (described as “Number of cycles” in the tables) in a case where the discharge capacity reached 80% of the initial capacity is shown in Tables 1 and 2.

TABLE 1

| | | Example 1 | Example 2 | Example 3 | Example 4 | Example 5 |
|---|---|---|---|---|---|---|
| Composition | Lithium salt | 1.0M LiFSI | 1.0M LiFSI | 1.0M LiFSI | 1.0M LiFSI | 1.0M LiFSI |
| of electrolyte | Compound of Formula (1) | AC1: 40 | AC1: 30 | AC2: 40 | AC3: 40 | AC3: 40 |
| solution | or Formula (2) | | | | | |
| | HFE | HFE1: 40 | HFE1: 50 | HFE2: 40 | HFE1: 40 | HFE2: 40 |
| | Non-fluorinated ether | DME: 20 | DME: 20 | DME: 20 | DME: 20 | DME: 20 |
| Number of substituents | | 1 | 1 | 1 | 1 | 1 |
| (compound of Formula (1) or Formula (2)) | | | | | | |
| Presence or absence of phase separation | | ○ | ○ | ○ | ○ | ○ |
| Specific gravity of electrolyte solution(g/cc) | | 1.2 | 1.3 | 1.2 | 1.2 | 1.2 |
| Discharge capacity (Ah) at 25° C. | | 6.8 | 6.9 | 6.8 | 6.8 | 6.8 |
| Discharge capacity (Ah) at −30° C. | | 5.1 | 5.2 | 5.1 | 5.0 | 5.1 |
| Number of cycles | | 131 | 130 | 132 | 129 | 133 |
| | | Example 6 | Example 7 | Example 8 | Example 9 | Example 10 |
| Composition | Lithium salt | 1.0M LiFSI | 1.0M LiFSI | 1.2M LiFSI | 1.2M LiFSI | 1.2M LiFSI |
| of electrolyte | Compound of Formula (1) | AC3: 25 | AC4: 40 | AC1: 40 | AC6: 30 | AC7: 30 |
| solution | or Formula (2) | | | | | |
| | HFE | HFE1: 25 | HFE2: 40 | HFE1: 30 | HFE1: 50 | HFE1: 50 |
| | Non-fluorinated ether | DMP: 50 | DME: 20 | DME: 30 | DME: 20 | DME: 20 |

| | | | | | |
|---|---|---|---|---|---|
| Number of substituents | 1 | 1 | 1 | 2 | 3 |
| (compound of Formula (1) or Formula (2)) | | | | | |
| Presence or absence of phase separation | ○ | ○ | ○ | ○ | ○ |
| Specific gravity of electrolyte solution(g/cc) | 1.1 | 1.2 | 1.1 | 1.3 | 1.3 |
| Discharge capacity (Ah) at 25° C. | 7.2 | 6.8 | 6.7 | 6.7 | 6.5 |
| Discharge capacity (Ah) at −30° C. | 5.3 | 5.3 | 5.5 | 5.2 | 5.3 |
| Number of cycles | 134 | 134 | 132 | 121 | 118 |

| | | Example 11 | Example 12 | Example 13 |
|---|---|---|---|---|
| Composition | Lithium salt | 1.0M LiFSI | 1.0M LiFSI | 1.0M LiFSI |
| of electrolyte | Compound of Formula (1) | HC1: 10 | HC2: 10 | HC2: 10 |
| solution | or Formula (2) | | | |
| | HFE | HFE1: 40 | HFE1: 40 | HFE1: 40 |
| | Non-fluorinated ether | DME: 50 | DME: 50 | DME: 50 |

| | | | |
|---|---|---|---|
| Number of substituents | 1 | 1 | 1 |
| (compound of Formula (1) or Formula (2)) | | | |
| Presence or absence of phase separation | ○ | ○ | ○ |
| Specific gravity of electrolyte solution(g/cc) | 1.3 | 1.3 | 1.3 |
| Discharge capacity (Ah) at 25° C. | 7.0 | 7.0 | 7.0 |
| Discharge capacity (Ah) at −30° C. | 5.5 | 5.5 | 5.4 |
| Number of cycles | 121 | 125 | 123 |

TABLE 2

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Composition | Lithium salt | 1.6M LiFSI | 1.0M LiFSI | 1.0M LiFSI | 1.0M LiFSI | 1.0M LiFSI | 1.0M LiFSI |
| of | compound of | AC5: 60 | AC5: 80 | AC1: 80 | AC2: 80 | AC3: 80 | AC4: 80 |
| electrolyte | Formula (1) or | | | | | | |
| solution | Formula (2) | | | | | | |
| | HFE | — | — | — | — | — | — |
| | Non-fluorinated | THF: 40 | DME: 20 | DME: 20 | DME: 20 | DME: 20 | DME: 20 |
| | ether | | | | | | |

| | | | | | | |
|---|---|---|---|---|---|---|
| Number of substituents | 1 | 1 | 1 | 1 | 1 | 1 |
| (compound of Formula (1) or | | | | | | |
| Formula (2)) | | | | | | |
| Presence or absence of phase | ○ | Phase | Phase | Phase | Phase | Phase |
| separation | | separation | separation | separation | separation | separation |
| Specific gravity of electrolyte | 1.3 | — | — | — | — | — |
| solution(g/cc) | | | | | | |
| Discharge capacity (Ah) | 6.5 | — | — | — | — | — |
| at 25° C. | | | | | | |
| Discharge capacity (Ah) | 0.2 | — | — | — | — | — |
| at −30° C. | | | | | | |
| Number of cycles | 95 | — | — | — | — | — |

| | | Comparative | Comparative | Comparative | Comparative | Comparative |
|---|---|---|---|---|---|---|
| | | Example 7 | Example 8 | Example 9 | Example 10 | Example 11 |
| Composition | Lithium salt | 4.0M LiFSI | 1.0M LiFSI | 1.0M LiFSI | 1.0M LiFSI | 4.0M LiFSI |
| of | compound of | HC2: 5 | HC2: 60 | — | — | — |
| electrolyte | Formula (1) or | | | | | |
| solution | Formula (2) | — | — | HFE1: 80 | HFE2: 80 | — |
| | HFE | DME: 95 | DME: 40 | DME: 20 | DME: 20 | DME: 100 |
| | Non-fluorinated | | | | | |
| | ether | | | | | |

| | | | | | |
|---|---|---|---|---|---|
| Number of substituents | | | | | |
| (compound of Formula (1) or | 1 | 1 | — | — | — |
| Formula (2)) | | | | | |
| Presence or absence of phase | ○ | Phase | ○ | ○ | ○ |
| separation | | separation | | | |
| Specific gravity of electrolyte | 1.4 | — | 1.5 | 1.5 | 1.4 |
| solution(g/cc) | | | | | |
| Discharge capacity (Ah) | 6.5 | — | 6.8 | 6.5 | 6.5 |
| at 25° C. | | | | | |
| Discharge capacity (Ah) | 0.1 | — | 5.1 | 5.1 | 0.1 |
| at −30° C. | | | | | |
| Number of cycles | 92 | — | 111 | 112 | 93 |

In Tables 1 and 2, the symbol “−” in the components of the electrolyte solution means that the electrolyte solution does not have the corresponding component, the symbol “−” in the presence or absence of phase separation means that the phase separation is not present, and the symbol “−” in the specific gravity of the electrolyte solution, the discharge capacity, and the number of cycles means that the specific gravity of the electrolyte solution, the discharge capacity, and the number of cycles are not measured.

From Tables 1 and 2, it can be seen that Examples 1 to 13, in which lithium secondary batteries using an electrolyte solution including, as a solvent, the cyclic compound represented by Formula (1) or Formula (2), the hydrofluoroether, and the ether not having a fluorine atom were used, have excellent cycle characteristics and do not undergo phase separation, as compared with Comparative Examples in which such an electrolyte solution was not used.

Next, the lithium-metal battery was investigated.

### Example 14

A lithium-metal battery (LMB) of Example 14 was manufactured as follows.

### (Preparation of Negative Electrode)

First, a clad material, in which an Li foil having a thickness of 20.0 μm and an electrolytic Cu foil having a thickness of 8.0 μm were joined, was prepared and punched to a predetermined size (43 mm×43 mm).

### (Manufacture of Positive Electrode)

Next, a positive electrode was manufactured. A mixture of 96 parts by mass of LiNi_{0.85}Co_{0.12}Al_{0.03}O₂ as a positive-electrode active material, 2.0 parts by mass of carbon black as a conductive aid, and 2.0 parts by mass of polyvinylidene fluoride (PVDF) as a binder was applied to one surface of a 12 μm-thick Al foil and press-molded. The molded product thus obtained was punched to a predetermined size (40 mm×40 mm) to obtain a positive electrode having a positive electrode current collector. In addition, the obtained positive electrode had a unit weight of 21 mg/cm².

### (Preparation of Separator)

A separator obtained by coating 2.0-μm polyvinylidene fluoride (PVDF) on both surfaces of a 12-μm polyethylene microporous membrane and having a predetermined size (50 mm×50 mm) was prepared as the separator.

### (Preparation of Electrolyte Solution)

An electrolyte solution was prepared as follows. Three kinds of solvents, butylbenzene, 1,1,2,2-tetrafluoroethyl-2,2,2-trifluoroethyl ether, and 1,2-dimethoxyethane, were mixed such that the contents of these solvents were each 40% by volume, 40% by volume, and 20% by volume. An electrolyte solution was obtained by dissolving LiN(SO₂F)₂ in the obtained mixed solution such that the molar concentration was 1.0 M.

### (Assembly of Battery)

The positive electrode current collector on which the positive electrode had been formed, the separator, and the negative electrode obtained as described above were laminated in this order such that the positive electrode faced the separator, thereby obtaining a laminate. Furthermore, a 100-μm Al terminal and a 100-μm Ni terminal were joined to the positive electrode current collector and the negative electrode, respectively, by ultrasonic welding, and then inserted into an outer container of a laminate. Then, the electrolyte solution obtained as described above was injected in the outer container. The outer container was sealed to obtain a lithium secondary battery.

### Comparative Example 12

A lithium secondary battery was obtained in the same manner as in Example 14, except that the electrolyte solution was prepared using the solvent described in Table 3.

In Table 3, the columns of “Number of substituents (cyclic compound of Formula (1))”, “Presence or absence of phase separation”, and “Specific gravity of electrolyte solution” represent the same items as in Tables 1 and 2.

### [Measurement of Discharge Capacity]

The manufactured lithium secondary battery was CC-charged at 0.8 A until the voltage reached 4.2 V (initial charge), and then CC-discharged at 0.8 A until the voltage reached 3.0 V (initial discharge). Next, the lithium secondary battery was CC-charged at 2.4 A until the voltage reached 4.2 V and then CC-discharged at 2.4 A until the voltage reached 3.0 V in an environment of a temperature of 25° C. or 0° C. The discharge capacity at a temperature of 25° C. is shown in Tables 1 and 2.

### [Evaluation of Cycle Characteristics]

The cycle characteristics of the lithium secondary batteries manufactured in Example 14 and Comparative Example 12 were evaluated based on the capacity retention rate in the following manner.

The manufactured lithium secondary battery was subjected to initial charge and initial discharge (first cycle). Next, in second and subsequent cycles, a cycle where the lithium secondary battery was CC-charged at 2.4 A until the voltage reached 4.2 V and then CC-discharged at 2.4 A until the voltage reached 3.0 V was repeated until the 100th cycle in an environment at a temperature of 25° C. Here, a ratio (100th cycle capacity/second cycle capacity) of a capacity (100th cycle capacity) obtained from the 100th cycle discharge to a capacity (second cycle capacity) obtained from the second cycle discharge is determined, and the ratio is shown in Table 3 as the capacity retention rate (%).

TABLE 3

| | | | Comparative |
|---|---|---|---|
| | | Example 1 | Example 12 |
| Composition of | Lithium salt | 1.0M LiFSI | 1.0M LiFSI |
| electrolyte solution | Compound of | AC1: 40 | |
| | Formula (1) | | |
| | HFE | HFE1: 40 | HFE2: 80 |
| | Non-fluorinated ether | DME: 20 | DME: 20 |

| | | |
|---|---|---|
| Number of substituents | 1 | — |
| (compound of Formula (1)) | | |
| Presence or absence of phase separation | — | — |
| Specific gravity of | 1.2 | 1.5 |
| electrolyte solution (g/cc) | | |
| 25° C. Discharge capacity (mAh) | 6.5 | 6.5 |
| Capacity retention rate (%) | 131 | 112 |

In Table 3, the symbol “−” for the component of the electrolyte solution or the number of substituents thereof means that the corresponding component is not present, and the symbol “−” for the presence or absence of phase separation means that phase separation is not present.

From Table 3, it can be seen that Example 14, in which the lithium-metal battery using the electrolyte solution including the cyclic compound represented by Formula (1), the hydrofluoroether, and the ether not having a fluorine atom as a solvent was used, has a higher energy density and more excellent cycle characteristics, as compared with Comparative Example 12, in which such an electrolyte solution was not used.

The lithium secondary battery created by using the electrolyte solution of the present invention has excellent cycle characteristics, and therefore, it has industrial applicability as an electrolyte solution for a power storage device to be used in various applications.

What is claimed is:

1. An electrolyte solution for a lithium secondary battery, the electrolyte solution comprising:
a cyclic compound represented by Formula (1) or Formula (2);
a hydrofluoroether;
an ether not having a fluorine atom; and
a lithium salt, 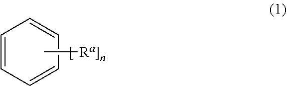
(in Formula (1), n is an integer of 0 or more and 3 or less, and R^{a} is a monovalent saturated hydrocarbon group having 1 or more and 10 or less carbon atoms) 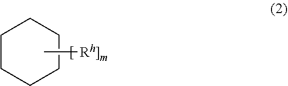
(in Formula (2), m is an integer of 0 or more and 3 or less, and R^{h} is a monovalent saturated hydrocarbon group having 1 or more and 10 or less carbon atoms).

2. The electrolyte solution according to claim 1,
wherein the cyclic compound is included in an amount of 5% by volume or more and 60% by volume or less with respect to a total amount of solvent components of the electrolyte solution.

3. The electrolyte solution according to claim 1,
wherein the cyclic compound is included in an amount of 10% by volume or more and 55% by volume or less with respect to a total amount of solvent components of the electrolyte solution.

4. The electrolyte solution according to claim 1,
wherein in Formula (1), n is 1.

5. The electrolyte solution according to claim 1,
wherein in Formula (2), m is 0 or 1.

6. The electrolyte solution according to claim 1,
wherein the electrolyte solution includes the cyclic compound represented by Formula (1).

7. The electrolyte solution according to claim 1,
wherein a specific gravity of the electrolyte solution is 1.0 g/cc or more and 1.3 g/cc or less.

8. The electrolyte solution according to claim 1,
wherein the cyclic compound is at least one selected from the group consisting of n-butylbenzene, tert-butylbenzene, isobutylbenzene, sec-butylbenzene, propylbenzene, ethyltoluene, 1,3,5-trimethylbenzene, cyclohexane, methylcyclohexane, and ethylcyclohexane.

9. The electrolyte solution according to claim 1,
wherein the ether not having a fluorine atom is at least one selected from the group consisting of 1,2-dimethoxyethane and 1,2-dimethoxypropane.

10. The electrolyte solution according to claim 1,
wherein the lithium salt includes LiN(SO₂F)₂.

11. The electrolyte solution according to claim 1,
wherein the hydrofluoroether is a chain-like fluorine compound having at least one of a monovalent group represented by Formula (A) or a monovalent group represented by Formula (B), 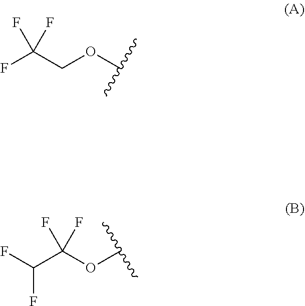 [SMILES: *OCC(F)(F)F ; *OC(F)(F)C(F)F]
(in Formulae (A) and (B), a wavy line represents a bonding site in the monovalent group).

12. A lithium secondary battery comprising:
the electrolyte solution according to claim 1.

13. The lithium secondary battery according to claim 12,
wherein lithium metal is deposited on a surface of a negative electrode and the deposited lithium metal is dissolved to perform charge/discharge.

14. The lithium secondary battery according to claim 13, further comprising:
a negative electrode consisting of a negative electrode current collector not having a negative-electrode active material.
